(19) United States
(12) Patent Application Publication
(10) Pub. No.: US 2006/0065744 A1
(43) Pub. Date: Mar. 30, 2006

(54) IC-tag-attached sheet and image forming apparatus

(75) Inventors: Shinichi Tai, Ebina-shi (JP); Kenichi Kobayashi, Ebina-shi (JP); Tomoshi Hara, Minamiashigara-shi (JP); Kazuyuki Tsukamoto, Ashigarakami-gun (JP); Koji Morofuji, Ebina-shi (JP); Tsutomu Udaka, Ebina-shi (JP); Ryuichiro Maeyama, Ebina-shi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/081,499

(22) Filed: Mar. 17, 2005

(30) Foreign Application Priority Data
Sep. 15, 2004 (JP) 2004-268286
Sep. 15, 2004 (JP) 2004-268287
Sep. 16, 2004 (JP) 2004-270459
Sep. 17, 2004 (JP) 2004-272223

(51) Int. Cl. G06K 19/06; G06F 3/12; G06F 17/00; G08B 13/14

(52) U.S. Cl. 235/492; 235/375; 340/572.8; 358/1.15

(57) ABSTRACT

The present invention provides an IC-tag-attached sheet wherein an IC tag is attached in a margin of a sheet for image formation.

This application claims priority under 35 U.S.C. §119 of Japanese Patent Applications No. 2004-268286 filed on Sep. 15, 2004, No. 2004-268287 filed on Sep. 15, 2004, No. 2004-270459 filed on Sep. 16, 2004, and No. 2004-272223 filed on Sep. 17, 2004, the entire content of which are hereby incorporated by reference.

### BACKGROUND OF THE INVENTION

1. Field of the Invention

The present invention relates to a sheet for image formation to which an IC tag is attached.

2. Description of the Related Art

Japanese Patent Application Laid-open Publication No. 2000-285203 discloses a technique of causing an image forming apparatus to form an image on a surface of a sheet in accordance with data written in an IC tag attached to the sheet. With the technique, as image formation is performed using data written in an IC tag, an image can be reproduced on a sheet with no degradation in image.

However, in the related art, a position on a sheet where an IC tag is attached is not provided. Accordingly, when the related art is used, an IC tag can be attached to an area on a sheet where an image is to be formed. Consequently, due to an asperity caused by thickness of the IC tag, an image formed on the sheet is distorted.

The present invention has been made with a view to addressing the problem discussed above, and provides a technique of, when an image is formed on an IC-tag-attached sheet, preventing distortion, due to an asperity caused by thickness of the IC tag, of the image.

### SUMMARY OF THE INVENTION

To address the problems discussed above, the present invention provides an IC-tag-attached sheet where an IC tag is attached in a margin of a sheet for image formation.

According to the IC-tag-attached sheet, it becomes possible to prevent distortion, due to an asperity caused by thickness of an IC tag, of an image formed on a sheet.

### BRIEF DESCRIPTION OF THE DRAWINGS

Embodiments of the present invention will be described in detail with reference to the following figures, wherein:

FIG. 1 is a diagram illustrating a configuration of IC-tag-attached sheet 10;

FIG. 2 is a diagram illustrating a configuration of IC-tag-attached sheet 10;

FIG. 3 is a diagram illustrating a configuration of IC-tag-attached sheet 10;

FIG. 4 is a diagram illustrating a configuration of IC-tag-attached sheet 10;

FIG. 5 is a diagram illustrating a configuration of IC-tag-attached sheet 10;

FIG. 6 is a diagram illustrating a configuration of IC-tag-attached sheet 10;

FIG. 7 is a diagram illustrating a configuration of IC-tag-attached sheet 10;

FIG. 8 is a diagram illustrating positions on IC-tag-attached sheet 10 to which IC tag 12 is attached.

FIG. 9 is a diagram illustrating a configuration of IC-tag-attached sheet 10;

FIG. 10 is a block diagram illustrating a configuration of image forming apparatus 20;

FIG. 11 is a diagram illustrating a configuration of tag attaching unit 207;

FIG. 12 is a flowchart illustrating operations of image forming apparatus 20;

FIG. 13 is a diagram illustrating a configuration of the entire system according to a modification of a second embodiment;

FIG. 14 is a block diagram illustrating a configuration of image forming apparatus 20′;

FIG. 15 is a flowchart illustrating operations of image forming apparatus 20′;

FIG. 16 is a flowchart illustrating operations of image forming apparatus 20′;

FIG. 17 is a block diagram illustrating a configuration of image forming apparatus 20″.

### DETAILED DESCRIPTION OF THE INVENTION

Embodiments of the present invention will be described with reference to the drawings.

### 1. First Embodiment

First, a configuration of an IC-tag-attached sheet 10 will be described with reference to FIG. 1.

FIG. 1 is a diagram illustrating a configuration of an IC-tag-attached sheet 10 according to the first embodiment of the present invention. Sheet 11 is a sheet on which an image is to be formed by a commonly used image forming apparatus. Sheet 11 may be made of any material, such as paper or plastic film. The size of sheet 11 may be a size such as A4, A3, B5, or B4 defined by JIS (Japanese Industrial Standards), which sizes are commonly used for image formation by an image forming apparatus, or it may be a nonstandard size.

IC tag 12 is an RFID (Radio Frequency IDentification) tag which exchanges data with an external device in a non-contacting manner. IC tag 12 is broadly composed of nonvolatile semiconductor memory capable of writing/reading of data, and a coiled antenna, and is able to communicate with an external device via microwave or induction field. IC tag 12 pre-stores in the memory, data such as attributes (the size, thickness, or type) of sheet 11 to which IC tag 12 is attached. In addition, image data may be written in the memory of IC tag 12 during image formation by a tag reader provided in an image forming apparatus. Alternatively, a user may write data in the memory of IC tag 12 using a tag reader, after image formation.

It should be note that IC tag 12 may be an IC tag which exchanges data with an external device in a contacting manner.

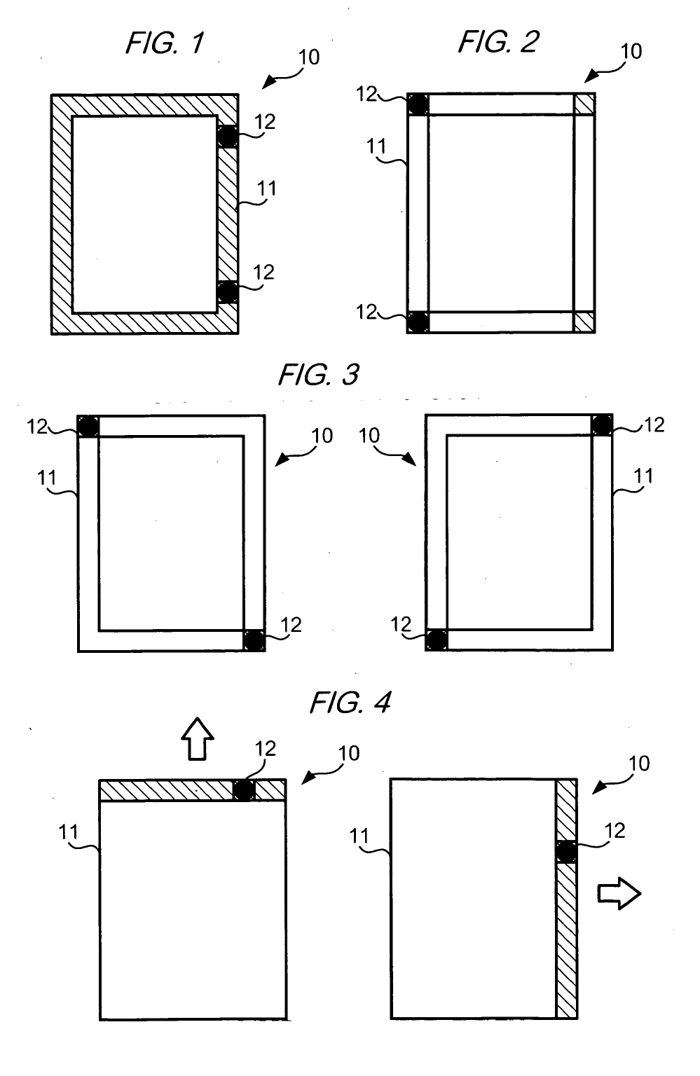

Second, a position on IC-tag-attached sheet 10, to which IC tag 12 is attached, will be described with reference to FIGS. 2 to 7.

The present embodiment is characterized in that IC tag 12 is attached in a margin (a shaded area of FIG. 1) of sheet 11. This margin of sheet 11 is, for example, an area of 20 to 30 millimeters from an edge of sheet 11, which is an area not usually used for formation of an image.

It should be noted that the number of IC tags 12 attached to sheet 11 may be two or more. If data is stored in plural IC tags, when an IC tag is damaged, data can be stored in other IC tags.

IC tag 12 may be attached to any of the four corners of sheet 11, as shown in FIG. 2. If IC tag 12 is so attached, IC tag 12 can be removed easily from a corner of sheet 11 with, for example, scissors.

Two IC tags 12 may be attached to two diagonally opposing corners of sheet 11, as shown in FIG. 3. If two IC tags 12 are so attached, a problem of providing two tag readers in an image forming apparatus can be avoided, as discussed below.

When causing an image forming apparatus to control sheet conveyance or image formation in accordance with attributes of sheet 11, the image forming apparatus is required to prepare a tag reader for reading attribute data of sheet 11 written in IC tag 12. If a single IC tag 12 is attached to a corner of sheet 11, depending on which direction the right surface of sheet 11 faces, or whether the longitudinal direction of sheet 11 is parallel or perpendicular toward a direction of conveyance, a position of IC tag 12 can be positioned right or left in relation to the image forming apparatus. Consequently, to read data of IC tag 12 with certainty, the image forming apparatus needs a tag reader in each position where right and left margins of sheet 11 pass by. However, if two IC tags 12 are attached to two diagonally opposing corners of sheet 11, as shown in FIG. 3, IC tag 12 always exists in both right and left margins in relation to the image forming apparatus. Accordingly, a tag reader is needed in only a single position, either on the right or left side.

IC tag 12 may be attached to the front end of sheet 11, as shown by the shaded areas in FIG. 4. If IC tag 12 is so attached, by reading data written in IC tag 12 by a tag reader of an image forming apparatus, a position of IC tag 12, i.e. a position of the front end of sheet 11, can be detected. Consequently, an accurate starting point of an image formation on sheet 11 can be determined in the image forming apparatus. Additionally, since the front end of sheet 11 is thicker where IC tag 12 is attached, and is weighed down by IC tag 12, sheet 11 is likely to become detached from a roller or a belt.

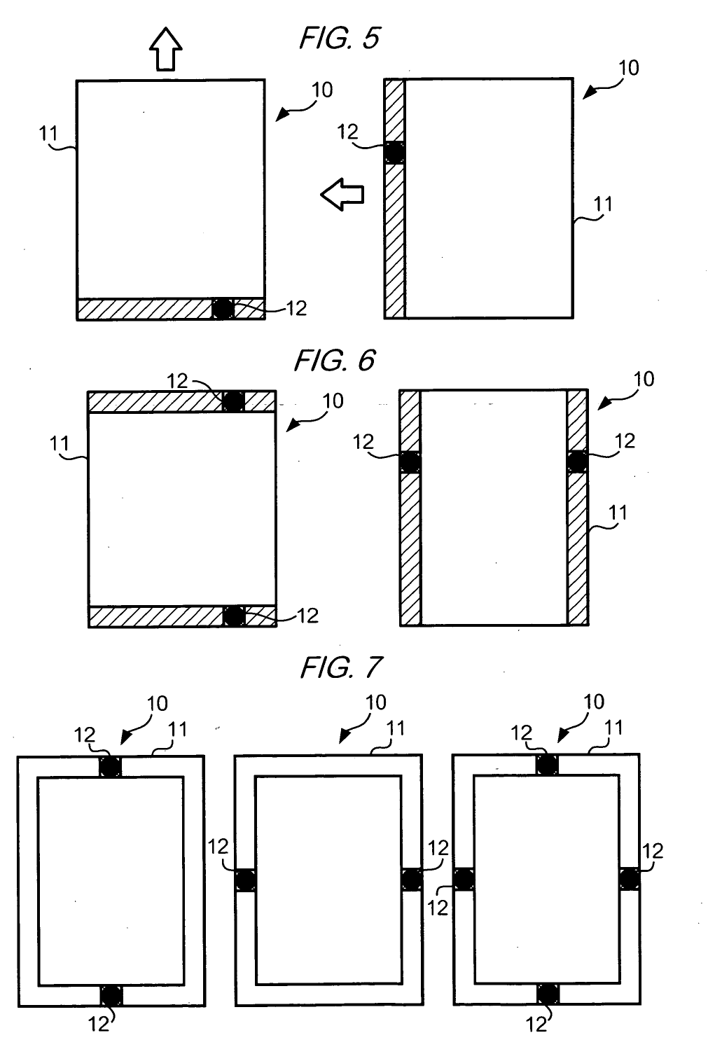

If IC-tag-attached sheet 10 of FIG. 4 is used in an inverted position, as shown in FIG. 5, it the rear end of sheet 11 is detected. Consequently, an edge adjusting process of sheet 11 by a post-processing device after image formation becomes possible.

If IC tags 12 are attached to both the front end and the rear end of sheet 11, as shown in FIG. 6, the length of sheet 11 can also be detected.

If IC tags 12 are attached to the centers of the front and rear ends of sheet 11, or additionally to the centers of the right and left ends of sheet 11, as shown in FIG. 7, the skew of IC-tag-attached sheet 10 toward its conveyance direction can be detected in addition to the length of sheet 11.

It should be noted that IC tag 12 may be attached to sheet 11 in any method. For example, IC tag 12 may be glued to sheet 11, or may be caught between fabrics constituting a paper when the paper is made.

As discussed above, according to the present embodiment, when an image is formed on an IC-tag-attached sheet, distortion of an image formed on the sheet due to an asperity caused by thickness of the IC tag can be prevented.

### 1.1 First Modification of First Embodiment

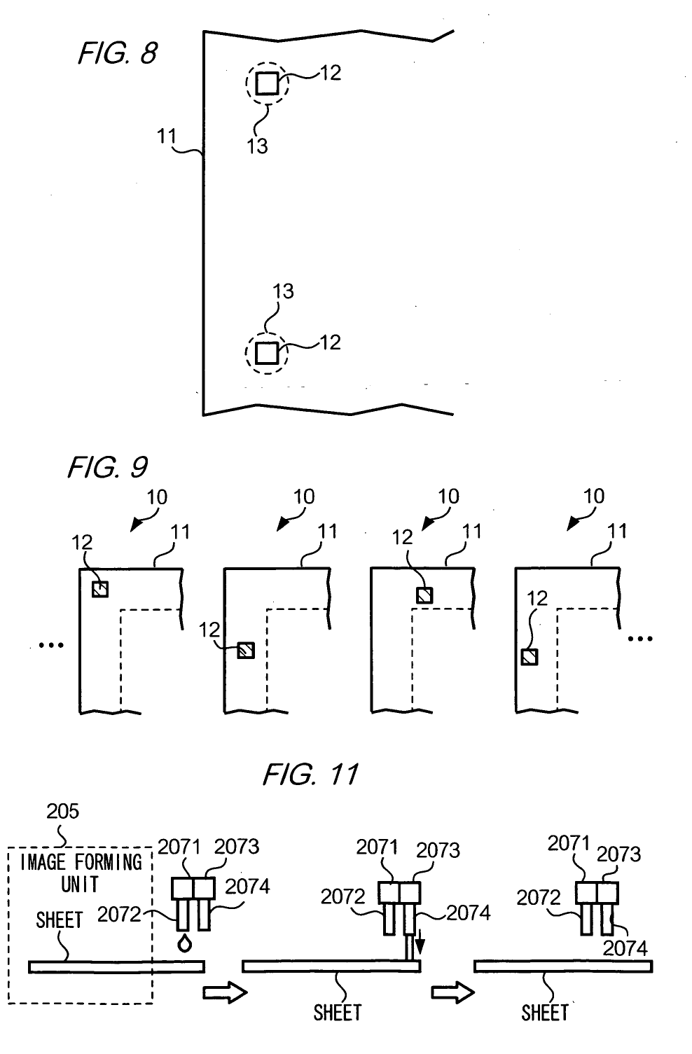

An IC-tag-attached sheet according to the present modification is characterized in that, as shown in FIG. 8, IC tag 12 is attached in a margin of sheet 11 and the position is located in a punch position on sheet 11.

FIG. 8 is a diagram illustrating positions on IC-tag-attached sheet 10 to which IC tag 12 is attached. As shown in FIG. 8, in IC-tag-attached sheet 10 according to the present modification, IC tag 12 is attached to each punch position on sheet 11 which is to be punched by a punch. On each punch position of sheet 11, circle 13 showing an outline of a hole is printed. Circle 13 may be replaced with a mark showing an outline of IC tag 12. The punch is, for example, a two-hole punch which is commercially available, and wherein the distance between the centers of the two holes is 80 millimeters, and the diameter of the holes is 6 millimeters. The number, distance, and diameter of a hole of the punch may be arbitrarily selected, and the punch may be an automatic punch provided in a post-processing device of an image forming apparatus. The punch positions are located 40 millimeters above and 40 millimeters below the center of one side of sheet 11, which is appropriate for storage in a standard 2-ring binder.

According to the IC-tag-attached sheet described above, an IC tag can be removed easily by using a punch. Also, since an IC tag is attached at a predetermined position, i.e. a punch position, a user can find the IC tag easily when removing it. Also, since two IC tags are attached to a sheet, if one IC tag is damaged, data can be stored in the other IC tag. Also, since the size of an IC tag is smaller than or equal to the diameter of a punch hole, an IC tag can be removed with certainty. Also, since marks showing a punch position are printed on a sheet, a user can easily find punch positions, i.e. positions of IC tags.

It should be note that in the modification, an IC tag which is larger than the diameter of a punch hole may be attached to a sheet. In this case, although a piece of an IC tag can remain on a sheet, at lease data written in the IC tag is made unusable.

### 1.2 Second Modification of First Embodiment

An IC-tag-attached sheet according to the present modification is characterized in that, as shown in FIG. 9, an IC tag 12 is attached in a margin of sheet 11 and the position of IC tag 12 is determined at random for every sheet 11.

FIG. 9 is a diagram showing positions on IC-tag-attached sheet 10 to which IC tag 12 is attached. As shown in FIG. 9, a position of IC tag 12 is changed for every sheet 11. Methods of determining a position of IC tag 12 include a method that employs an algorithm for finding coordinates on sheet 10 using random numbers generated by a public random number generating method.

According to the modification, since an IC tag is attached at a randomly-determined position for every sheet, when image formation is performed on sheets to which such an IC tag is attached, IC tags of the sheets are prevented from repeatedly making contact at a fixed position of a roller or a belt, and damage to the roller or the belt can therefore be avoided. Additionally, when sheets are piled up, a problem of uneven stacking of the sheets caused by the thickness of the IC can be avoided.

It should be noted that a position of an IC tag on a sheet determined at random may be in any of the four corners of a sheet. If an IC tag is so attached, the IC tag can be removed easily from a corner of a sheet with, for example, scissors.

### 2. Second Embodiment

The second embodiment describes an image forming apparatus having a function of preparing IC-tag-attached sheet 10 discussed in the first embodiment.

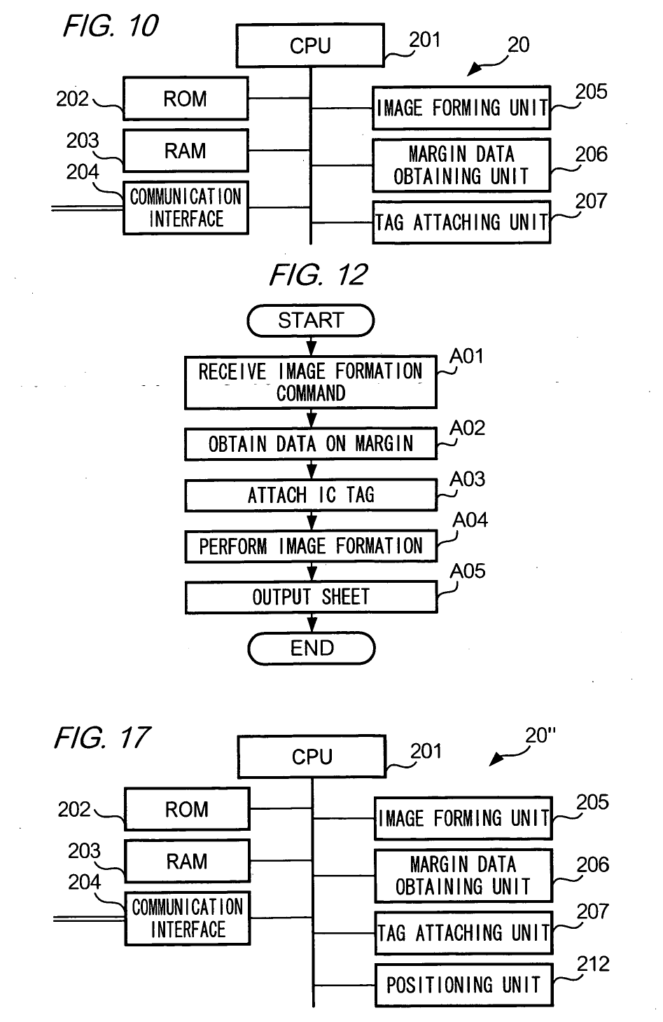

First, a configuration of image forming apparatus 20 will be described with reference to FIG. 10.

FIG. 10 is a block diagram illustrating a configuration of image forming apparatus 20.

CPU (Central Processing Unit) 201 control operations of image forming apparatus 20 by reading and executing programs from ROM (Read Only Memory) 202. ROM 202 stores the programs for controlling operations of image forming apparatus 20. RAM (Random Access Memory) RAM 203 is used as a work area when CPU 201 executes a program.

Communication interface 204 is connected to a network (not shown), and relays communications with external terminals (not shown).

Image forming unit 205 is a unit which forms an image on a surface of a sheet in a commonly known electro-photographic manner. Image forming unit 205 is broadly composed of a charging unit for charging a photosensitive drum, an exposing unit for forming an electrostatic latent image on the photosensitive drum on the basis of image data, a developing unit for developing the electrostatic latent image with toner, a transferring unit for transferring the toner image onto a sheet, and a fixing unit for fixing the toner image on the sheet (none of which are shown).

Margin data obtaining unit 206 is a unit which obtains data on a margin of sheet 11 where an image is to be formed by image forming unit 205. The data on a margin may be obtained by analyzing received image data, or by extracting from received document data, the document data being created by a word processor.

Tag attaching unit 207 is a unit which attaches IC tag 12 in a margin designated by margin data obtained by margin data obtaining unit 206. As shown in FIG. 11, tag attaching unit 207 is composed of tank 2071 for storing adhesives, nozzle 2072 for discharging the adhesives, holder 2073 for storing plural IC tags 12, and attaching unit 2074 for attaching IC tag 12. When sheet 11 is conveyed to tag attaching unit 207, adhesive stored in tank 2071 is discharged to a surface of sheet 11 from nozzle 2072. Consequently, sheet 11 is moved and, when the position where the adhesive was applied is located directly under attaching unit 2074, attaching unit 2074 takes out IC tag 12 from holder 2073 and crimps the IC tag 12 on sheet 11.

Now, operations of image forming apparatus 20 will be described with reference to FIG. 12.

FIG. 12 is a flowchart illustrating operations of image forming apparatus 20. When image forming apparatus 20 is powered on, CPU 201 reads and executes programs from ROM 202, and thereby controls components of image forming apparatus 20, as shown in FIG. 12.

CPU 201 receives a command sent from an external terminal via communication interface 204, which command includes image data (Step AO 1). This image data is analyzed by margin data obtaining unit 206, and CPU 201 obtains data on a margin from margin data obtaining unit 206 (Step A02). When sheet 11 fed by a paper feed unit (not shown) provided in image forming apparatus 20 reaches tag attaching unit 207, CPU 201 causes tag attaching unit 207 to attach IC tag 12 in a margin of sheet 11 designated by the obtained margin data (Step A03). CPU 201 supplies the image data included in the command to image forming unit 205, and causes it to perform an image formation on sheet 11 to which IC tag 12 was attached (Step A04). Sheet 11 on which an image was formed is output to a paper output tray (not shown) attached to image forming apparatus 20 (Step A05).

As discussed above, in image forming apparatus according to the present embodiment is configured to attach an IC tag in a margin of a sheet for image formation. Consequently, when an image is formed on a sheet to which an IC tag is attached, distortion of an image formed on the sheet due to an asperity caused by thickness of the IC tag can be prevented.

### 2.1 First Modification of Second Embodiment

An image forming apparatus according to the present modification is characterized by, in addition to attaching of IC tag 12 in a margin of sheet 11, writing data in IC tag 12 attached to sheet 11, and by using the written data, reporting to a user of completion of an image formation.

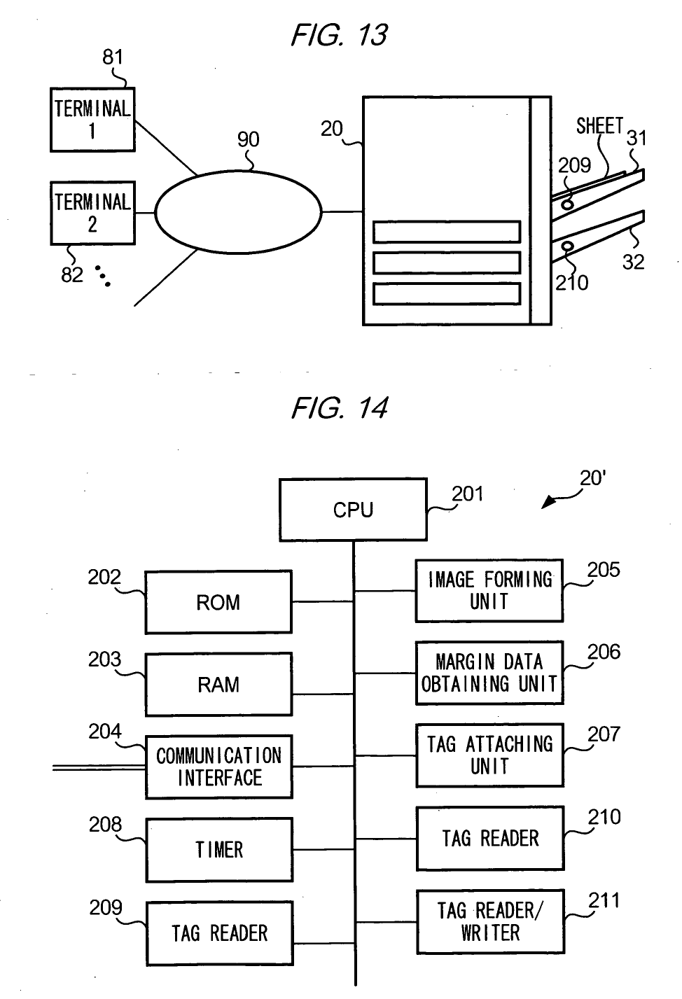

First, a configuration of the entire system according to the present modification will be described with reference to FIG. 13.

As shown in FIG. 13, the entire system is composed of image forming apparatus 20′, terminals 81 and 82, and network 90, and image forming apparatus 20′ and terminals 81 and 82 are interconnected via network 90. Terminals 81 and 82 are personal computers with a communication function. Image forming apparatus 20′ has a function of receiving image data via network 90, and on the basis of the received image data, forming an image on a surface of a sheet in an electro-photographic manner. Furthermore, image forming apparatus 20′ has paper output trays 31 and 32. More than three paper output trays may be attached to image forming apparatus 20′.

Now, a configuration of image forming apparatus 20′ will be described with reference to FIG. 14.

As shown in FIG. 14, the configuration of image forming apparatus 20′ according to the present modification differs from that of image forming apparatus 20 according to the second embodiment in further having timer 208, tag readers 209 and 210, and tag reader/writer 211. Regarding the other components of image forming apparatus 20′, CPU 201, ROM 202, RAM 203, communication interface 204, image forming unit 205, margin data obtaining unit 206, and tag attaching unit 207, since each component has the same function as that of a counterpart of image forming apparatus 20, descriptions of the components will be omitted.

Timer 208 is a unit which measures a time elapsed after sheet 11 on which an image has been formed is output to paper output tray 31 or 32.

Tag readers 209 and 210 are provided at paper output trays 31 and 32, respectively, and read data from IC tag 12 attached to sheet 11 output to paper output trays 31 and 32.

Tag reader/writer 211 is provided downstream of attaching unit 2074 of tag attaching unit 207, and writes data in IC tag 12 attached to sheet 11. Tag reader/writer 211 may be located upstream of tag attaching unit 207.

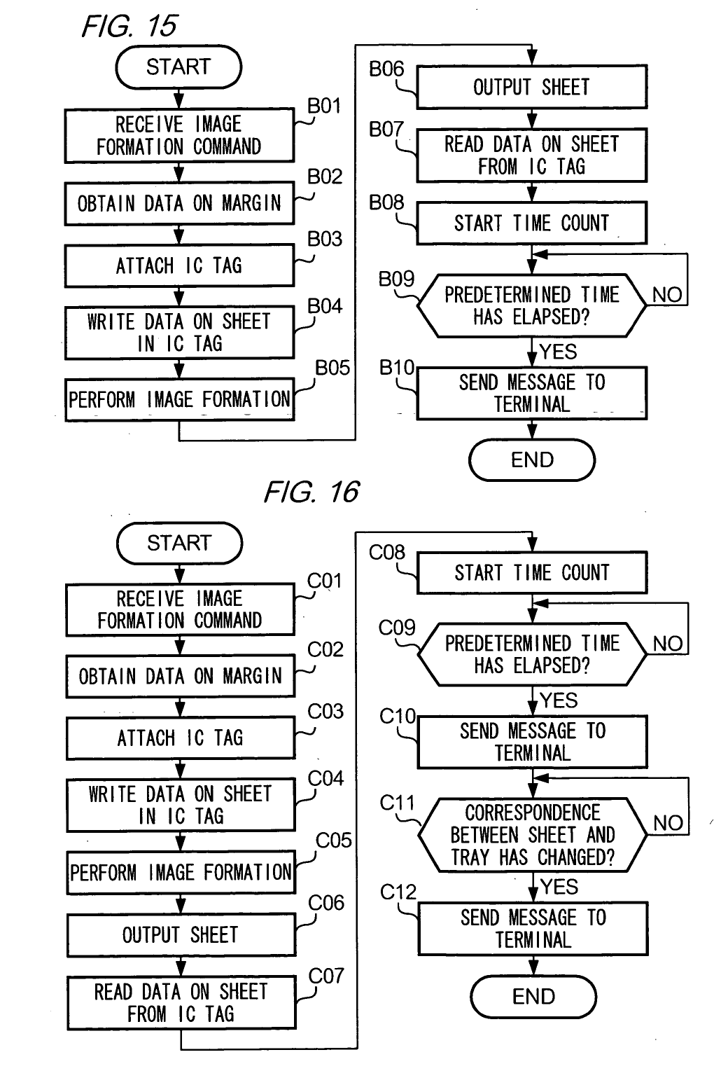

Now, operations of image forming apparatus 20′ will be described with reference to FIG. 15.

FIG. 15 is a flowchart illustrating operations of image forming apparatus 20′. When image forming apparatus 20′ is powered on, CPU 201 reads and executes programs from ROM 202, and thereby controls components of image forming apparatus 20′, as shown in FIG. 15.

CPU 201 receives a command sent from terminal 81 via communication interface 204, which command includes image data, identification information for uniquely identifying the image data (e.g. a filename), and a communication address of the source, i.e. terminal 81 (Step B01). This image data is analyzed by margin data obtaining-unit 206, and CPU 201 obtains data on a margin from margin data obtaining unit 206 (Step B02). When sheet 11 fed by a paper feed unit (not shown) provided in image forming apparatus 20′ reaches tag attaching unit 207, CPU 201 causes tag attaching unit 207 to attach IC tag 12 in a margin of sheet 11 designated by the obtained margin data (Step B03).

After IC tag 12 is attached to sheet 11, CPU 11 causes tag reader/writer 211 to write data in IC tag 12 attached to sheet 11 (Step B04). The data written by tag reader/writer 211 is the identification information of the image data and the communication address of terminal 81. CPU 201 supplies the image data included in the command to image forming unit 205, and causes it to perform an image formation on sheet 11 to which IC tag 12 was attached (Step B05).

Sheet 11 on which an image was formed is output to paper output tray 31 or 32 (Step B06). Tag reader 209 or 210 provided at paper output tray 31 or 32 reads data from IC tag 12 attached to output sheet 11 (Step B07), while timer 208 starts to measure a time from the point when data was read from IC tag 12 (Step B08). CPU 201 determines whether the time measured by timer 208 reaches a predetermined time (Step B09), and if it is determined that the predetermined time has elapsed (Step B09: YES), CPU 201 sends to the communication address of terminal 81 a message that sheet 11 on which an image was formed has been output (Step B10). Terminal 81, on receipt of the message, displays the message on a display of terminal 81 to inform a user to the effect. Consequently, the user can know that an image formation on sheet 11 has been completed, which can prevent the user from forgetting to retrieve sheet 11.

In the operation flow, if the user of terminal 81 designates terminal 82, to which the user wishes to pass an image-formed sheet 11, as the destination of the message when sending a command of a print instruction to image forming apparatus 20′, it becomes possible to cause image forming apparatus 20′ to send to terminal 82 a message that an image formation on sheet 11 has been completed.

Also, in the operation flow, a writing of data in IC tag 12 by tag reader/writer 211 may be performed before IC tag 12 is attached to sheet 11, not after IC tag 12 is attached.

Also, in the operation flow, in addition to a message that image formation on sheet 11 is completed, identification information of image data may be reported to the user, and thereby letting the user know an image which has been printed.

Also, in the operation flow, instead of sending a message to a user immediately after an elapsed time reaches a predetermined time, a message may be sent to a user after it is confirmed that the sheet still remains on an paper output tray. Specifically, after an elapsed time corresponding to identification information of image data reaches a predetermined time, identification information of image data is read from IC tags of all sheets on an paper output tray, and if the same identification information is read, a message is sent to a communication address associated with the identification information. Consequently, a problem of sending a message to a user who has already retrieved a sheet can be avoided.

when an elapsed time corresponding to data identification information reaches a predetermined value, reads data identification information from IC tags of all sheets on the paper output tray, and if a same identification information is read, reads from the storing unit a communication address stored in association with the identification information, and sends to the communication address a message that an image-formed sheet has been output to the paper output tray

Also, in the operation flow, in addition to a message that image formation on sheet 11 is completed, information on a paper output tray to which sheet 11 has been output may be reported to the user.

For example, in a case where sheet 11 output to a paper output tray is taken out by another user and returned to another paper output tray mistakenly, it would be convenient if an actual user of the paper output tray to which sheet 11 was returned can be informed. Below, a description of operations of image forming apparatus 20′ in this case will be made with reference to FIG. 16.

FIG. 16 is a flowchart illustrating operations of image forming apparatus 20′. In FIG. 16, operations in steps C01 to C10 are the same as those of FIG. 15 except step for C07. In step C07, data is read not only from IC tag 12 attached to sheet 11, but also from paper output tray 31 or 32 on which sheet 11 is placed. Paper output tray 31 or 32 can be identified by identifying tag reader 209 or 210 which reads data from IC tag 12 attached to sheet 11, since tag readers 209 and 210 are associated with paper output trays 31 and 32 respectively as shown in FIG. 13. Identification information on image data and a communication address to be reported, which has been read by tag reader 209 or 210 and tray identification information for identifying paper output tray 31 or 32 are stored in RAM 203 in association with each other.

CPU 201 causes tag readers 209 and 210 to read identification information on image data from IC tags 12 of all sheets 11 on paper output trays 31 and 32 at predetermined intervals, and determines whether correspondences between the read identification information and paper output trays match correspondences stored in RAM 203 (Step C11). If the determination is negative, CPU 201 identifies identification information of the changed correspondences, and sends to communication addresses associated with the identification information a message informing on which paper output tray 31 or 32 sheet 11 is placed. Correspondences do not match in a case where sheet 11 output to a paper output tray is taken out by another user and returned to another paper output tray mistakenly. In this case, since sheet 11 is not placed on a paper output tray designated by an actual user, s/he must look for sheet 11. However, according to the operation example discussed above, if sheet 11 is moved to another paper output tray, it becomes possible to report to a user the paper output tray to which sheet 11 was moved.

### 2.2 Second Modification of Second Embodiment

Image forming apparatus 20 according to the second embodiment may be provided with positioning unit 211 which determines a position on a sheet to which an IC tag is attached, at random for each sheet, and may prepare IC-tag-attached sheet 10 discussed in the second modification of the first embodiment.

FIG. 17 is a block diagram illustrating a configuration of image forming apparatus 20″. As shown in FIG. 17, the configuration of image forming apparatus 20″ according to the present modification differs from that of image forming apparatus 20 according to the second embodiment in further having positioning unit 212. Regarding the other components of image forming apparatus 20″, CPU 201, ROM 202, RAM 203, communication interface 204, image forming unit 205, margin data obtaining unit 206, and tag attaching unit 207, since each component has the same function as that of a counterpart of image forming apparatus 20, descriptions of the components will be omitted.

Positioning unit 212 is a unit which determines a position on sheet 11 to which IC tag 12 is attached, at random for each sheet 11. Specifically, positioning unit 212 determines the position using the method as described in the second modification of the first embodiment; namely, employing an algorithm for finding coordinates on sheet 11 using random numbers generated by a public random number generating method. The information on the position determined by positioning unit 212 is used when IC tag 12 is attached to sheet 11. For example, in a case of the flowchart of FIG. 12, the position information is used when IC tag 12 is attached in a margin of sheet 11 at Step A03. Consequently, IC-tag-attached sheet 10 discussed in the second modification of the first embodiment can be prepared.

As described above, the present invention provides an IC-tag-attached sheet wherein an IC tag is attached in a margin of a sheet for image formation.

According to an embodiment of the invention, the margin is an area not used for formation of an image.

According to another embodiment of the invention, plural IC tags are attached in the margin of the sheet for image formation.

According to another embodiment of the invention, the IC tag is attached to a corner in the margin of the sheet for image formation.

According to another embodiment of the invention, plural IC tags are attached to plural corners in the margin of the sheet for image formation.

According to another embodiment of the invention, an IC tag is attached to two diagonally opposing corners in the margin of the sheet for image formation.

According to another embodiment of the invention, the IC tag is attached to a punch position to be punched by a punch which is in the margin of the sheet for image formation.

According to another embodiment of the invention, plural IC tags are attached to punch positions to be punched by the punch which are in the margin of the sheet for image formation.

According to another embodiment of the invention, a size of the IC tag is smaller or equal to a diameter of a punch hole made by the punch.

According to another embodiment of the invention, the punch position is marked in the sheet for image formation.

Also, the present invention provides a batch of IC-tag-attached sheets wherein: an IC tag is attached in a margin of each sheet for image formation; and the position on which the IC tag is attached is determined at random in a margin of each sheet.

Also, the present invention provides an image forming apparatus including: an image forming unit which forms an image on a surface of a sheet in accordance with an image data; a margin data obtaining unit which obtains a margin data from the image data; and an IC tag attaching unit which attaches an IC tag in a margin of the sheet for image formation.

According to one embodiment of the invention, the image forming apparatus further includes: a positioning unit which determines a position on which the IC tag is attached at random for each sheet.

According to another embodiment of the invention, the image forming apparatus further includes: a receiving unit which receives a command including a data identification information for identifying the data used for image formation and a communication address to which a message is to be sent; a writing unit which writes the data identification information and the communication address in an IC tag attached to a sheet by the IC tag attaching unit; a paper output tray to which a sheet having an image formed by the image forming unit is output; a reading unit which is provided at the paper output tray, and reads the data identification information and the communication address written in the IC tag of the sheet which is output to the paper output tray; a storing unit which stores the data identification information and the communication address read by the reading unit, in association with each other; a time measuring unit which measures a time from a point when the data identification information and the communication address are read by the reading unit; and a reporting unit which reads a communication address stored in association with the identification information from the storing unit and sends a message that an image-formed sheet is in the paper output tray to the communication address when an elapsed time corresponding to the identification information reaches a predetermined value, and the image forming unit obtains the data identification information received by the receiving unit, and forms an image on a surface of a sheet in accordance with the data.

According to another embodiment of the invention, the reporting unit reads the data identification information from the IC tags of all sheets on the paper output tray when an elapsed time corresponding to the data identification information reaches a predetermined value, and reads the communication address stored in association with the identification information from the storing unit if the same identification information is read, and sends a message that an image-formed sheet is in the paper output tray to the communication address.

According to another embodiment of the invention, the image forming apparatus further includes: plural paper output trays; and a tray identifying unit which identifies a paper output tray on which a sheet is placed, and the reporting unit sends the tray identification information with the message, the tray identification information identifies a paper output tray identified by the tray identifying unit.

According to another embodiment of the invention, the image forming apparatus further includes: plural paper output trays; a tray identifying unit which identifies a paper output tray on which a sheet is placed; a tray information storing unit which stores the data identification information read by the reading unit and the tray identification information for identifying a paper output tray identified by the tray identifying unit, in association with each other; a determining unit which determines whether an association between the data identification information read by the reading unit and the tray identification information of a paper output tray identified by the tray identifying unit matches an association stored in the tray information storing unit; and a tray information reporting unit which sends a message expressing the sheet on which the IC tag storing the identification information is placed is in the paper output tray to the communication address stored in association with the identification information if the determining unit determines that the association does not match, and the reading unit reads the data identification information and the communication address written in the IC tags of all sheets which are output to the paper output tray, at predetermined intervals.

Also, the present invention provides an image forming method including: obtaining a data on a margin of a sheet on which an image is formed from the image data; determining a position on a sheet to which an IC tag is attached, at random for each sheet, attaching an IC tag to the position on a sheet determined in the position determining step, which is in the margin designated by the data on a margin obtained in the margin data obtaining step; and forming an image on a surface of the IC-tag-attached sheet prepared in the IC tag attaching step in accordance with the image data.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described to best explain the principles of the invention and its practical applications, to thereby enable others skilled in the art to understand various embodiments of the invention and various modifications thereof, to suit a particular contemplated use. It is intended that the scope of the invention be defined by the following claims and their equivalents.

What is claimed is:

1. An IC-tag-attached sheet wherein an IC tag is attached in a margin of a sheet for image formation.

2. An IC-tag-attached sheet according to claim 1, wherein the margin is an area not used for formation of an image.

3. An IC-tag-attached sheet according to claim 1, wherein a plurality of IC tags are attached in the margin of the sheet for image formation.

4. An IC-tag-attached sheet according to claim 1, wherein the IC tag is attached to a corner in the margin of the sheet for image formation.

5. An IC-tag-attached sheet according to claim 1, wherein a plurality of IC tags are attached to a plurality of corners in the margin of the sheet for image formation.

6. An IC-tag-attached sheet according to claim 1, wherein an IC tag is attached to two diagonally opposing corners in the margin of the sheet for image formation.

7. An IC-tag-attached sheet according to claim 1, wherein the IC tag is attached to a punch position to be punched by a punch which is in the margin of the sheet for image formation.

8. An IC-tag-attached sheet according to claim 7, wherein a plurality of IC tags are attached to punch positions to be punched by the punch which are in the margin of the sheet for image formation.

9. An IC-tag-attached sheet according to claim 7, wherein a size of the IC tag is smaller or equal to a diameter of a punch hole made by the punch.

10. An IC-tag-attached sheet according to claim 7, wherein the punch position is marked in the sheet for image formation.

11. A batch of IC-tag-attached sheets wherein:
an IC tag is attached in a margin of each sheet for image formation; and
the position on which the IC tag is attached is determined at random in a margin of each sheet.

12. An image forming apparatus comprising:
an image forming unit which forms an image on a surface of a sheet in accordance with an image data;
a margin data obtaining unit which obtains a margin data from the image data; and
an IC tag attaching unit which attaches an IC tag in a margin of the sheet for image formation.

13. An image forming apparatus according to claim 12, further comprising:
a positioning unit which determines a position on which the IC tag is attached at random for each sheet.

14. An image forming apparatus according to claim 12, further comprising:
a receiving unit which receives a command including a data identification information for identifying the data used for image formation and a communication address to which a message is to be sent;
a writing unit which writes the data identification information and the communication address in an IC tag attached to a sheet by the IC tag attaching unit;
a paper output tray to which a sheet having an image formed by the image forming unit is output;
a reading unit which is provided at the paper output tray, and reads the data identification information and the communication address written in the IC tag of the sheet which is output to the paper output tray;
a storing unit which stores the data identification information and the communication address read by the reading unit, in association with each other;
a time measuring unit which measures a time from a point when the data identification information and the communication address are read by the reading unit; and
a reporting unit which reads a communication address stored in association with the identification information from the storing unit and sends a message that an image-formed sheet is in the paper output tray to the communication address when an elapsed time corresponding to the identification information reaches a predetermined value,
wherein the image forming unit obtains the data identification information received by the receiving unit, and forms an image on a surface of a sheet in accordance with the data.

15. An image forming apparatus according to claim 14, wherein the communication address is a communication address of a source of the command.

16. An image forming apparatus according to claim 14, wherein the reporting unit sends the message and the identification information to the communication address.

17. An image forming apparatus according to claim 14, wherein the reporting unit reads the data identification information from the IC tags of all sheets on the paper output tray when an elapsed time corresponding to the data identification information reaches a predetermined value, and reads the communication address stored in association with the identification information from the storing unit if the same identification information is read, and sends a message that an image-formed-sheet is in the paper output tray to the communication address.

18. An image forming apparatus according to claim 14, further comprising:
a plurality of paper output trays; and
a tray identifying unit which identifies a paper output tray on which a sheet is placed,
wherein the reporting unit sends the tray identification information with the message, the tray identification information identifies a paper output tray identified by the tray identifying unit.

19. An image forming apparatus according to claim 14, further comprising:
a plurality of paper output trays;
a tray identifying unit which identifies a paper output tray on which a sheet is placed;
a tray information storing unit which stores the data identification information read by the reading unit and the tray identification information for identifying a paper output tray identified by the tray identifying unit, in association with each other;
a determining Unit which determines whether an association between the data identification information read by the reading unit and the tray identification information of a paper output tray identified by the tray identifying unit matches an association stored in the tray information storing unit; and
a tray information reporting unit which sends a message expressing the sheet on which the IC tag storing the identification information is placed is in the paper output tray to the communication address stored in association with the identification information if the determining unit determines that the association does not match,
wherein, the reading unit reads the data identification information and the communication address written in the IC tags of all sheets which are output to the paper output tray, at predetermined intervals.

20. An image forming method comprising:
obtaining a data on a margin of a sheet on which an image is formed from the image data;
determining a position on a sheet to which an IC tag is attached, at random for each sheet,
attaching an IC tag to the position on a sheet determined in the position determining step, which is in the margin designated by the data on a margin obtained in the margin data obtaining step; and
forming an image on a surface of the IC-tag-attached sheet prepared in the IC tag attaching step in accordance with the image data.
